(19) United States
(12) Patent Application Publication
(10) Pub. No.: US 2023/0082427 A1
(43) Pub. Date: Mar. 16, 2023

(54) AFOCAL ADAPTER FOR AN OPTICAL DEVICE

(71) Applicant: Torrey Pines Logic, Inc., San Diego, CA (US)

(72) Inventor: Leo Volfson, Del Mar, CA (US)

(73) Assignee: Torrey Pines Logic, Inc., San Diego, CA (US)

(21) Appl. No.: 17/794,009

(22) PCT Filed: Jan. 21, 2021
(86) PCT No.: PCT/US2021/014408

§ 371 Date: Jul. 20, 2022

Related U.S. Application Data
(60) Provisional application No. 62/963,625, filed on Jan. 21, 2020.

(51) Int. Cl. G02B 17/08; G02B 23/00; G02B 23/16

(52) U.S. Cl. CPC G02B 17/0896; G02B 23/145; G02B 23/16

(57) ABSTRACT

In one embodiment, an optical device includes an afocal magnifying lens train comprising a plurality of optical elements, which can magnify or demagnify an image of an object with zero or close to zero net convergence or divergence of the incoming light. The afocal magnifying lens train may include a catadioptric system. The optical device also includes an alignment adjustment mechanism to tilt, tip, or move one or more of the optical elements of the afocal magnifying lens train. The optical device further includes a clamp mechanism to secure the optical device to a rail or to another optical device.

### CROSS-REFERENCE TO RELATED APPLICATION

Pursuant to 35 U.S.C. § 119(e), this application claims the benefit of U.S. Provisional Patent Application Ser. No. 62/963,625, titled, “AFOCAL ADAPTER FOR AN OPTICAL DEVICE,” filed on Jan. 21, 2020, the entire contents of which are incorporated by reference herein.

### BACKGROUND

Afocal optical systems produce no net convergence or divergence of optical inputs. An afocal optical system can be formed by the combination of two focal optical systems. The rear focal point of a first focal optical system is coincident with the front focal point of the second focal optical system. Rays parallel to the axis in the object space are conjugate to rays parallel to the axis in the image space.

### SUMMARY

Example embodiments include an afocal adapter for an optical device. The afocal adapter includes a mounting mechanism, an afocal lens assembly, and a mechanism for adjusting one or more lenses of the afocal lens assembly. The mounting mechanism can include a screw-down clamp, a rail mount, such as a Picatinny rail mount, a friction fit mount, rubber gaskets, or other mounting mechanism. The mechanism for adjusting the one or more lenses can include windage and elevation adjustment drums coupled to adjustment turrets that contact a support arm supporting the one or more lenses of the afocal adapter.

An afocal adapter can be mounted onto an optical device (e.g., by a clamp or other mount) or adjacent the optical device (e.g., on a rail in front of the optical device). The afocal adapter includes a mounting system that clamps onto the end of another optical device. In some embodiments, the afocal adapter can be mounted in front of a mounted optical device, using, e.g., a rail system, such as a Picatinny rail system. Other mounting mechanisms can be used, such as friction fit mounts, screw-based mounts, threaded mounts, clamps, or other mechanisms.

The afocal adapter can include a fixed magnification optical system or can include a variable magnification optical system.

In some embodiments, the adapter is alignable to an optical device. Alignment can be achieved by either turrets adjusting windage and elevation. In some embodiments, alignment of the afocal adapter to the optical device can be achieved by rotation of the afocal adapter itself, or by any other mechanism, including tilting or tipping or shifting the afocal device in front of the optical device. Alignment allows for the straight optical axis of view for the underlying optical device through the afocal adapter.

The afocal adapter is mated to the scope using a clamp in this example embodiment. The scope can be a rifle scope or spotting scope, but in general, the afocal adapter can be paired with other types of optical devices, such as night vision devices, thermal imaging devices, displays, compasses, or any other electronic or optical subsystem.

### BRIEF DESCRIPTION OF THE DRAWINGS

FIG. 1 is a schematic diagram of an example afocal adapter for an optical device in accordance with embodiments of the present disclosure.

FIGS. 2A-B are simplified cross-sectional diagrams of the example afocal adapter of FIG. 1 in accordance with embodiments of the present disclosure.

FIG. 3 is a schematic diagram of the example afocal adapter of FIG. 1 paired with a scope on a rail in accordance with embodiments of the present disclosure.

FIG. 4 is a schematic diagram of another example afocal adapter with a scope mounting clamp in accordance with embodiments of the present disclosure.

FIG. 5 is a schematic diagram of the afocal adapter of FIG. 4 clamped onto a scope in accordance with embodiments of the present disclosure.

FIG. 6 is a simplified diagram of another example afocal adapter that includes an internal device and a catadioptric optical system in accordance with embodiments of the present disclosure.

Figures are not drawn to scale.

### DETAILED DESCRIPTION

For a variety of reasons, some optical devices, such as rifle or spotting scopes, have fixed magnification. Fixed magnification scopes can magnify the image of an object at a fixed (not adjustable or variable) magnification. In addition, most, if not all, fixed magnification scopes are passive optical devices that provide magnification and focusing capabilities of optical light without more. This disclosure describes an afocal magnifying adapter for an optical device. The afocal magnifying adapter can increase the magnification of the optical device. In some embodiments, the afocal magnifying adapter can include internal devices, such as internal displays, laser range finder, thermal or night vision optics, etc. The afocal magnifying adapter can be clamped onto the front of the optical device or attached to a rail in front of the optical device. The afocal magnifying adapter can, therefore, enhance the optical device in a non-invasive way.

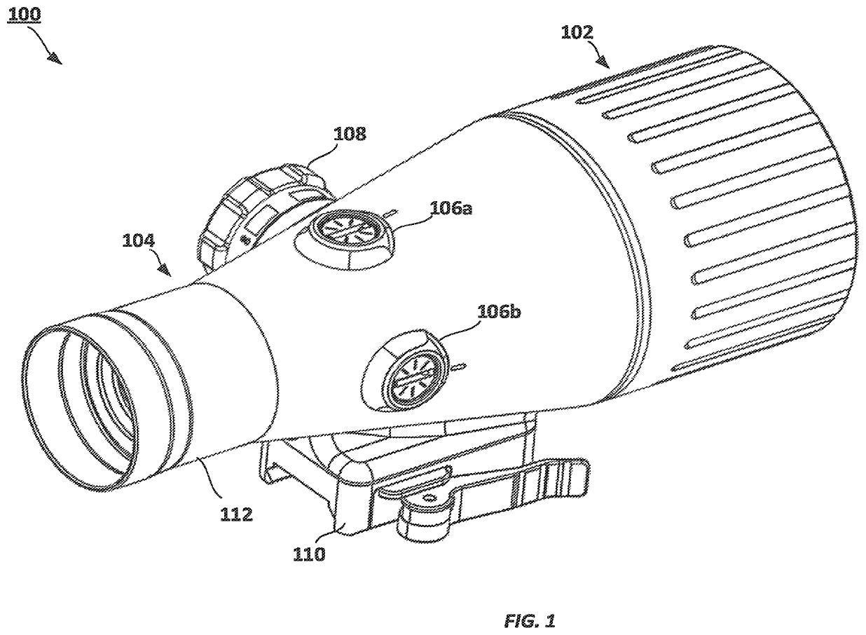

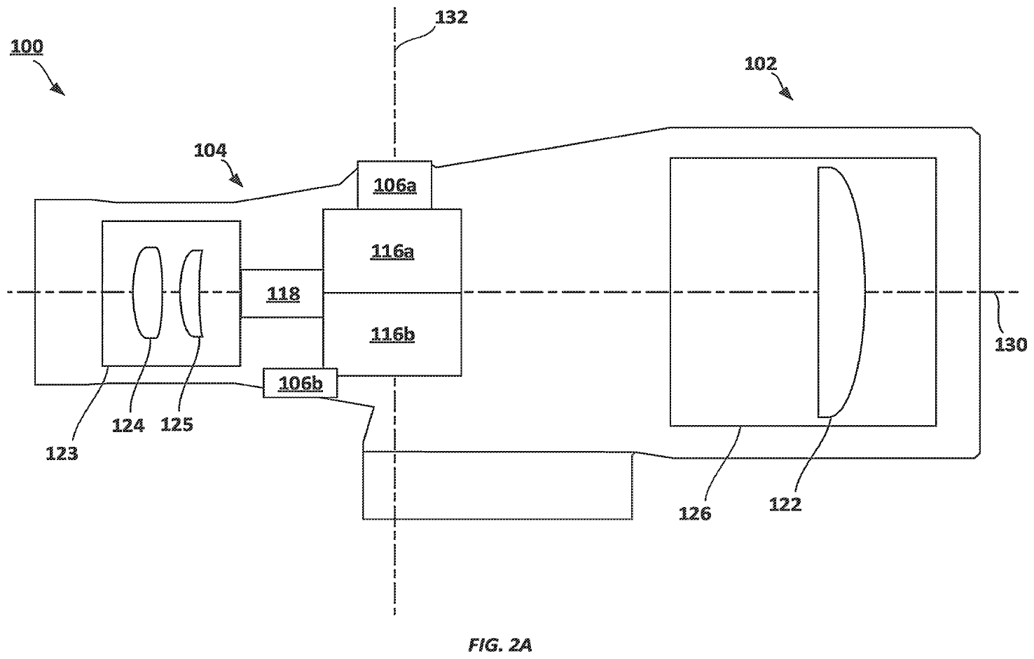

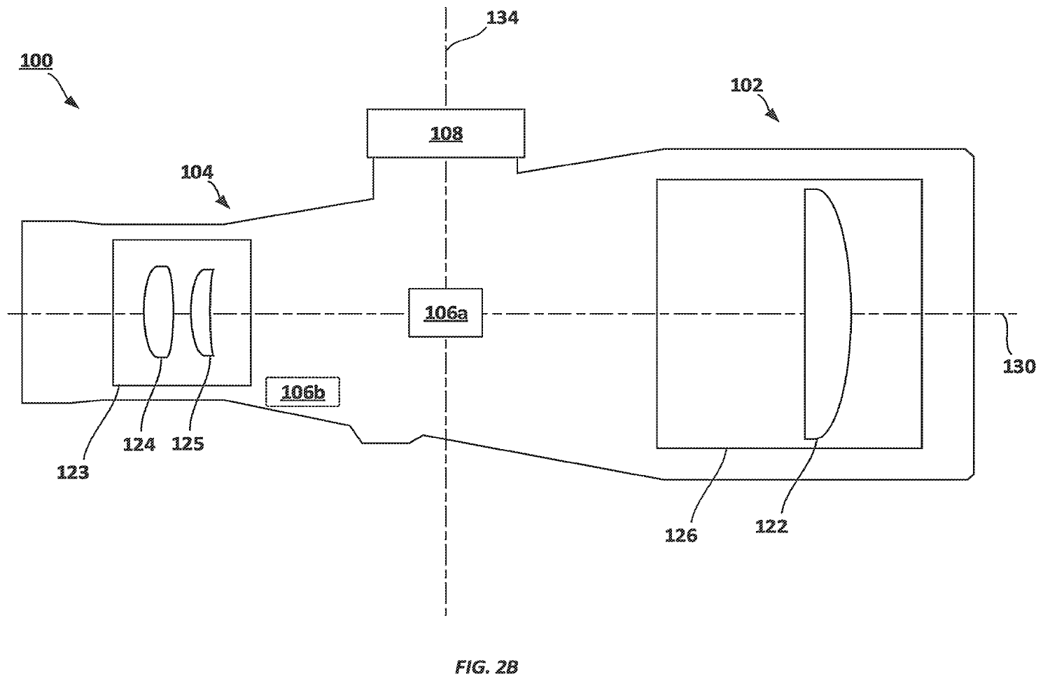

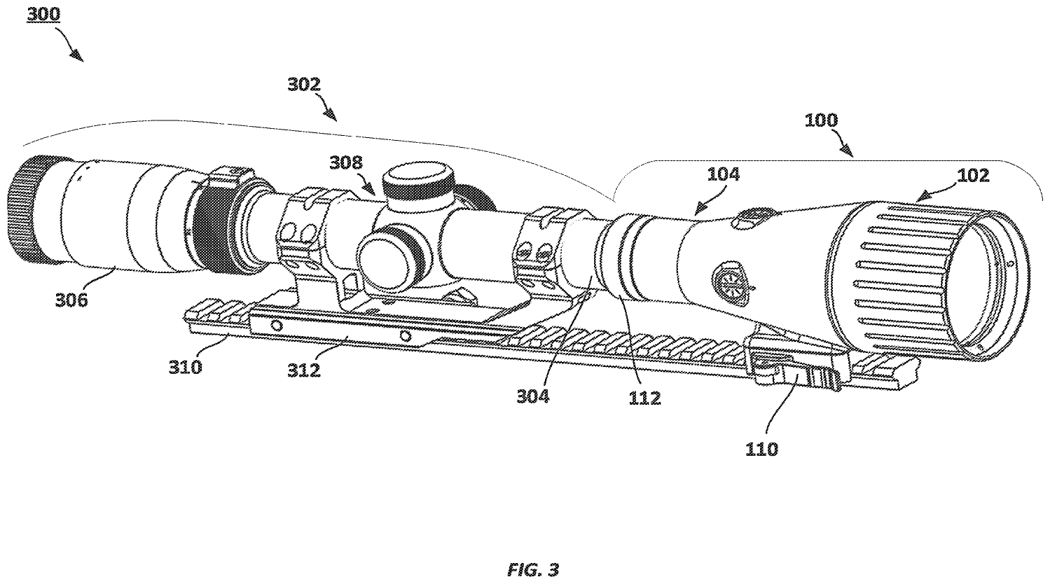

FIG. 1 is a schematic diagram of an example afocal adapter 100 for an optical device in accordance with embodiments of the present disclosure. Afocal adapter 100 is an optical device that can include one or more lenses (and in some cases lenses and mirrors) to magnify the image of an object with zero or close to zero net convergence or divergence of the incoming light. The afocal adapter 100 (previously referred to as the afocal magnifying adapter) can include two optical portions: an objective portion 102 and an ocular portion 104. The term “ocular” in this instance is used for simplicity, but it is understood that the light emitted from the ocular portion is intended to be directed into the objective lens of another optical device. The ocular portion can also be referred to as the focal portion, and the ocular lenses that make up the ocular lens train can be referred to as focal lenses and the focal lens train. The objective portion 102 can also be called an input portion and the ocular portion 104 can be called an output portion. The light from an object would enter the afocal adapter 100 through an objective lens at the objective or input portion 102 and the light would exit the afocal adapter at the ocular or output portion 104. The afocal adapter 100 includes a mechanism to aid in aligning the light emitted from the ocular portion 104 with the optical path of the optical device. For example, the afocal adapter 100 can include a tip-tilt adjustment mechanism, shown in more detail in FIGS. 2A-B. The tip-tilt adjustment mechanism can allow a user to adjust tip and tilt using adjustment knobs 106a and 106b. Tip-tilt is an adjustment of one or more lenses about an axis perpendicular to the long optical axis of the optical train. The tip-tilt adjustment mechanism can allow the afocal adapter 100 to be optically aligned with the paired optical device.

The afocal adapter 100 also includes a focus adjustment mechanism. The focus adjustment mechanism be used to focus the incoming light. The focus adjustment mechanisms, for example, can move one or more lenses of the ocular portion 104 (“ocular” lenses) in a direction along the long axis of the optical path. The afocal adapter 100 includes a focus adjustment knob 108 for focusing the incoming light.

The afocal adapter 100 includes a rail mount 110. Rail mount 110 can be a rail mount for a Picatinny rail system or other type of rail system. Rail mount 110 can be a quick connect/quick disconnect rail mount that includes a lever lock, which may allow for the adapter to be quickly removed without changing alignment. Other types of rail mounts are contemplated, such as flip-to-side mounts that allow the afocal adapter to rotate out of the optical path but still be mechanically coupled to the rail.

In some embodiments, the afocal adapter 100 includes a shroud 112 that can cover the objective portion of the paired optical device. The shroud 112 can aid with alignment and can block out ambient light. The shroud can be made of rubber, plastic, or a flexible material to fix over the paired optical device without permitting light to enter the optical path of the paired optical device.

FIGS. 2A-B are simplified cross-sectional diagrams of the example afocal adapter of FIG. 1 in accordance with embodiments of the present disclosure. As mentioned previously, the afocal adapter 100 includes an objective portion 102 and an ocular portion 104. Each portion 102, 104 may include one or more lenses to magnify or demagnify an image of an object. In the example shown, the objective portion 102 includes an objective lens 122, and the ocular portion 104 includes an ocular lens 124. Together, the objective lens 122 and the ocular lens 124 form an afocal magnifying lens train having an optical path along axis 130. In certain embodiments, the objection portion 102, ocular portion 104, or both, may include additional lenses or other types of optical elements in an optical train (e.g., forming an objective lens train and/or an ocular lens train). For example, an objective lens train (e.g., 122) can include one or more lenses for receiving light and directing the light towards one or more lenses of an ocular lens train (e.g., 124 and 125). The objective lens train can be supported by an objective lens cradle 126.

The objective lens cradle 126 can be adjusted for tip-tilt using an alignment adjustment mechanism, part of which is shown in FIG. 2A. Knob 106a can control a first direction of tip-tilt adjustment by adjustment mechanism 116a. Adjustment mechanism 116a can be a screw adjustment or cantilever. For example, adjustment mechanism 116a provides alignment adjustment about an axis perpendicular to axes 130 and 132 (i.e., axis 134 shown in FIG. 2B). Knob 106b can control a second direction of tip-tilt adjustment by adjustment mechanism 116b. For example, adjustment mechanism 116b provides alignment adjustment about an axis perpendicular to axes 130 and 134 (i.e., axis 132 shown in FIG. 2A).

In some embodiments, the objective cradle 126 can carry both the objective lens train (including objective lens 122) and the ocular cradle 123 that supports the ocular lens train (e.g., 124 and 125). The alignment adjustment mechanism, therefore, can adjust tip-tilt for the afocal magnifying lens train, while still allowing the focus adjustment mechanism to adjust the position of the ocular lenses independently. In some embodiments, the alignment adjustment mechanism operates only ono the ocular lens train.

The afocal adapter 100 also includes an ocular portion 104. Ocular portion 104 can include an ocular train as described above. The ocular train may include one or more ocular lenses (e.g., 124 and 125), which are supported by the ocular lens cradle 123. The ocular lens cradle 123 can be adjusted for focus using a focus adjustment mechanism 118 and focus knob 108. The focus adjustment mechanism can move one or more ocular lenses (e.g., 125, or the ocular cradle 123) in a direction along the long optical axis 130.

The lens alignment mechanism can include a mechanism to position the lens to align one or more lenses of the afocal magnifying lens train with a reticle or other aiming aid in the paired optical device. The alignment mechanism can include windage or left/right adjustment and elevation or up/down adjustment. The lenses can be supported by a cantilevered arm or cradle upon which the adjustment mechanism contacts. An adjustment drum can be manually manipulated or electrically manipulated to move an adjustment turret, which pushes on the arm supporting the lens. The adjustment turret can be moved by rotating the adjustment drum. For example, knobs 106a—b can be adjustment drums that can be manually or electrically rotated to cause the adjustment turret to push or pull the cradle holding one or more lenses of the afocal magnifying lens train.

Put simply, various embodiments are contemplated with respect to the alignment adjustment mechanism: the objective lens train can be adjusted, the ocular lens train can be adjusted, or the entire afocal magnifying lens train can be adjusted. The alignment adjustment mechanism can be used to align the afocal magnifying lens train with a paired optical device, such as a rifle scope, binoculars, spotting scope, etc.

FIG. 3 is a schematic diagram 300 of the example afocal adapter 100 of FIG. 1 paired with a scope 302 on a rail 310 in accordance with embodiments of the present disclosure. The afocal adapter 100 can be paired with an optical device, which in this example, is a rifle scope 302. The rifle scope 302 can include an objective side 304 and an ocular side 306. The afocal adapter 100 can mate with the objective side 304 of the rifle scope 302 using a shroud 112. In some embodiments, the afocal adapter can rest adjacent to the objective side 304 of rifle scope 302 without a shroud. Once paired, light enters the afocal adapter at objective portion 102 (i.e., objective lens in object portion 102) and exits the rifle scope 302 through an ocular lens at ocular side 306.

The rifle scope 302 includes a rail mount 312 to support the rifle scope 302 on a rifle or other object on rail 310. Rail 310 can be a Picatinny rail or other type of rail. Rail mount 312 can be a quick disconnect or other type of rail mount. The afocal adapter 100 also includes a rail mount 110 that is compatible with the rail 310 to secure the afocal adapter 100 to the rail 310.

Once paired with the optical device, one or more lenses of the afocal magnifying lens train can be adjusted to align with the aiming aid of the optical device, such as a reticle on a rifle scope, using the alignment adjustment mechanism. Once aligned, the afocal adapter 100 can be removed from rail 310. When replaced on the rail 310, assuming the rifle scope 302 is not changed in alignment, the lenses afocal adapter 100 should maintain its alignment with the lenses and/or reticle of the rifle scope 302.

The rifle scope 302 can also include a windage and elevation adjustment, as well as a reticle adjustment mechanism (together, adjustment mechanism 308). Adjustment mechanism 308 can be used to first zero and align the rifle scope 302 prior to pairing the rifle scope 302 with the afocal adapter 100.

It is understood that the optical device can be a rifle scope, spotting scope, binoculars, or other type of optical device.

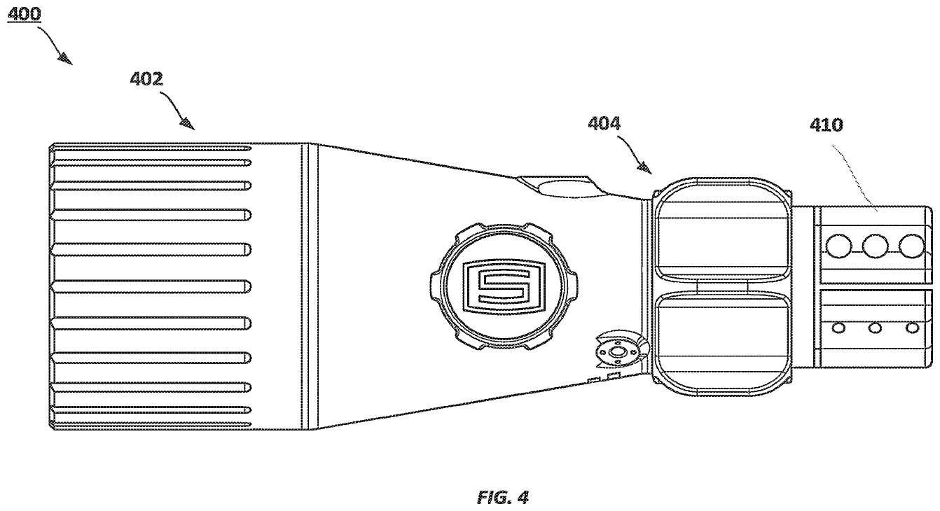

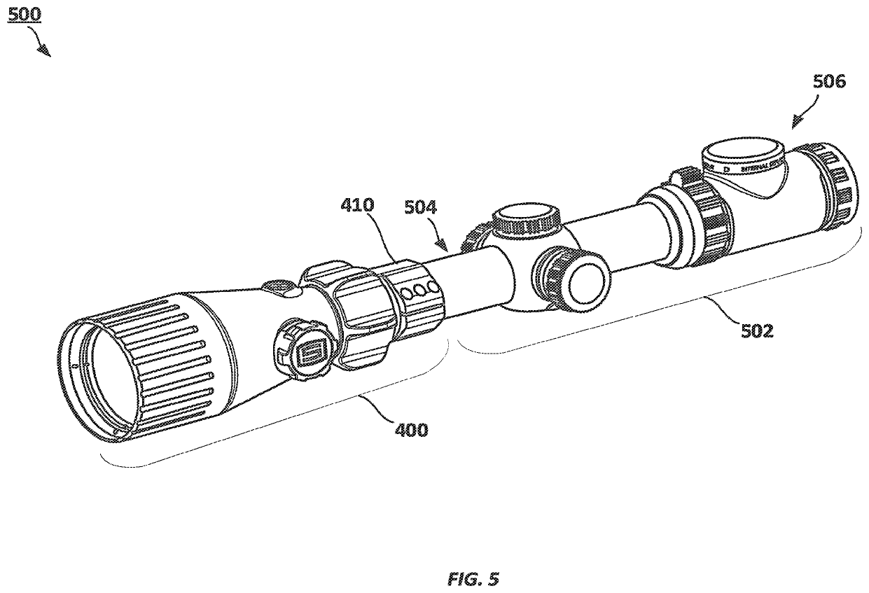

FIG. 4 is a schematic diagram of another example afocal adapter 400 with a scope mounting clamp 410 in accordance with embodiments of the present disclosure. FIG. 5 is a schematic diagram 500 of the afocal adapter of FIG. 4 clamped onto a scope in accordance with embodiments of the present disclosure. FIGS. 4 and 5 are discussed together:

The afocal adapter 400 includes an objective portion 402 that houses an objective lens train. Afocal adapter 400 includes an ocular or focal portion 404 that houses an ocular or focal lens train. The objective lens train and the ocular or focal lens train together are referred to as the afocal magnifying lens train.

Afocal adapter 400 is similar to afocal adapter 100, except that afocal adapter 400 does not include a rail mount. Rather, afocal adapter 400 includes a scope mounting clamp 410. Scope mounting clamp 410 can include substantially circular receptacle area to receive the objective side 504 of a scope 502, as shown in FIG. 5. The scope mounting clamp 410 can use screws to tighten the clamp around the objective side 504 of the paired scope 502. In some embodiments, the scope mounting claim 410 can provide sufficient light blocking from ambient light or other environmental conditions so as to act as a shroud. Thus, like entering the objective portion 402 of the afocal adapter 400 exits the rifle scope ocular side 506 with little to no interference from ambient sources.

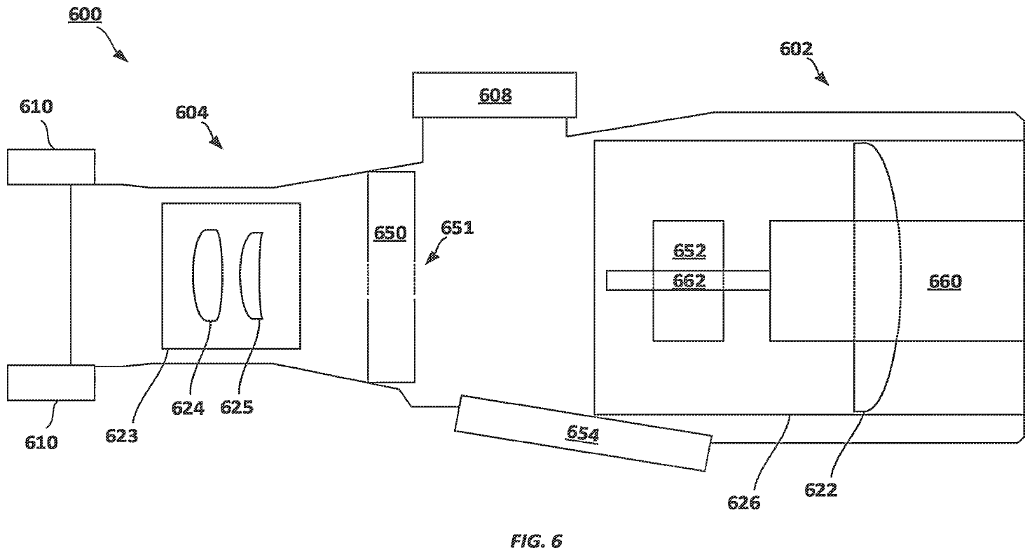

FIG. 6 is a simplified diagram of another example afocal adapter 600 that includes an internal device 660 and a catadioptric optical system in accordance with embodiments of the present disclosure. The afocal adapter 600 is similar to that shown in FIGS. 1 and 4. The afocal adapter 600 includes a scope mounting clamp 610 to couple the adapter 600 to a scope (e.g., as shown in FIG. 5), and could be used with a rail mount in addition to or in lieu of the scope mounting clamp 610. The afocal adapter 600 also includes an ocular lens train that includes one or more ocular or focal lenses (e.g., 624, 625) supported by an ocular lens cradle 623. Ocular lens cradle 623, or the lenses/optical elements within the cradle 623 (e.g., 624, 625) can be adjusted along a long axis of the optical path by a focus adjustment mechanism 608. Further, in some embodiments, the ocular lens cradle 623, or the lenses/optical elements within the cradle 623 (e.g., 624, 625), can be adjusted using an alignment adjustment mechanism such as the ones described above.

The afocal adapter 600 includes a catadioptric system to accommodate the inclusion of an internal device 660. The catadioptric system includes an objective lens 622, mirror 650, and mirror 652. As shown in FIG. 6, the objective lens 622 may be formed with a cavity in the center (indicated by dotted lines in FIG. 6), and the internal device 660 may be disposed at least partially within the cavity of the lens 622. Together, the mirrors 650, 652 may form a mirror lens that acts to reflect light from the objective lens 622 through the aperture 651. That is, the mirrors 650 and 652 can focus light from the objective lens towards the ocular lens train that includes lenses 624, 625. As shown, each of the mirrors may be formed with a cavity in the center (as indicated by dotted lines in FIG. 6). For example, the mirror 650 may define a circular cavity (aperture 651) formed in the center to allow light to pass from the objective portion 602 to the ocular portion 604 of the adapter 600. The mirror 652 may include a cavity formed therein to accommodate a portion of the device 660 or another device (which may be disposed at least partially within the cavity of the mirror 652 similar to the system 662 shown in FIG. 6). In the example shown, the objective lens 622 and mirror 652 are supported by an objective lens cradle 626. The catadioptric system can be aligned to the optical path of the paired optical device using an alignment adjustment mechanism, which can include a tip-tilt system as shown in FIG. 2A-B, e.g., by adjusting the position of the objective lens 622, one or both of the mirrors 650, 652, or the cradle 626. The alignment adjustment mechanism can also adjust the ocular lens train including lenses 624, 625 in some embodiments, or the alignment adjustment mechanism can only adjust the ocular lens train and not the catadioptric system.

The internal device 660 can include a laser range finder, a thermal imager, a night-vision imager, optical sighting device, etc. For example, the internal device 660 may include a display configured to project an image that is overlayed on a real view or is over-written on the real view provided by a lens train of the afocal adapter 600. The display can project information from another device in certain embodiments, such as a laser range finder, thermal imager, or night-vision imager. In some embodiments, the display can show information from devices outside the adapter 600, such as, for example, information provided via a Bluetooth connection (e.g., showing that a call or text message is being received on a mobile device).

The information from the internal device 660 can be fed through an optical system 662 for integration within the optical path of the afocal magnifying lens train. In some embodiments, the optical system 662 can include an internal display device to display information, such as distance, windage, elevation, or other information. The information output from the internal device 660 can be included within the optical path and transmitted to a user using the optical device. The afocal adapter 600 can include electronics 654, which can include a power source, processor, memory, communications controller, and other electronic components. The electronics 654 may be coupled to the internal device 660, optical system 662, or other components of the afocal adapter 600.

It will be understood that the afocal adapter 600 may include additional, fewer, or other components than those shown. For example, the afocal adapter 600 may include aspects described above with respect to the afocal adapter 100 (e.g., adjustment mechanisms 116a, 116b, 118, and knobs 106a, 106b, 108).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

### Example Embodiments

Example 1 relates to an optical device comprising: an afocal magnifying lens train comprising a plurality of optical elements; an alignment adjustment mechanism to tilt, tip, or move one or more of the optical elements of the afocal magnifying lens train; and a clamp mechanism to secure the optical device to a rail or to another optical device.

Example 2 includes the subject matter of Example 1, wherein the afocal magnifying lens train comprises one or more lenses to magnify or demagnify an image of an object.

Example 3 includes the subject matter of Example 1 or 2, wherein the afocal magnifying lens train comprises lenses that receive light and transmit light with zero or close to zero net convergence of light.

Example 4 includes the subject matter of any of Examples 1-3, wherein the afocal magnifying lens train comprises an objective lens proximate to a first end of the optical device and an ocular lens proximate to a second end of the optical device opposite the first end.

Example 5 includes the subject matter of any of Examples 1-4, wherein the afocal magnifying lens train comprises a catadioptric system.

Example 6 includes the subject matter of Example 5, wherein the catadioptric system comprises an objective lens and a mirror lens.

Example 7 includes the subject matter of any of Examples 5-6, further comprising an electronic device proximate an objective lens of the afocal magnifying lens train.

Example 8 includes the subject matter of Example 7, wherein the electronic device is positioned within one or more of a cavity defined by the objective lens and a cavity defined by a mirror of the mirror lens.

Example 9 includes the subject matter of any of Examples 7-8, wherein the electronic device comprises one or more of an internal display, a laser range finder, an infrared detector, a night-vision imager, a thermal imager, and an optical sighting device.

Example 10 includes the subject matter of Example 9, wherein the electronic device is configured to project an image that is overlaid on a real image provided by the afocal magnifying lens train.

Example 11 includes the subject matter of any of Examples 1-10, further comprising: a first cradle to support a first set of optical elements of the afocal magnifying lens train, the first set comprising an objective lens; and a second cradle to support a second set of optical elements of the afocal magnifying lens train, the second set comprising an ocular lens.

Example 12 includes the subject matter of Example 11, wherein the alignment adjustment mechanism is to tilt, tip, or move one or more of the first set of optical elements.

Example 13 includes the subject matter of Example 11, wherein the alignment adjustment mechanism is to tilt, tip, or move one or more of the second set of optical elements.

Example 14 includes the subject matter of any of Examples 1-13, further comprising a focus adjustment mechanism to move the one or more optical elements of the afocal magnifying lens train along an optical axis of the afocal magnifying lens train to adjust a focus of the afocal magnifying lens train.

Example 15 includes the subject matter of any of Examples 1-14, wherein the alignment adjustment mechanism is a first alignment adjustment mechanism to tilt, tip, or move one or more of the elements along a first axis, and the optical device further comprises a second alignment adjustment mechanism to tilt, tip, or move one or more of the optical elements along a second axis orthogonal to the first axis.

Example 16 includes the subject matter of any of Examples 1-15, wherein the clamp mechanism comprises a rail mount.

Example 17 includes the subject matter of Example 16, further comprising an adapter to surround an objective lens of another optical device.

Example 18 includes the subject matter of any of Examples 1-17, wherein the clamp mechanism comprises a clamp to mount the optical device onto another optical device.

Example 19 includes the subject matter of any of Examples 1-18, wherein the clamp mechanism comprises a quick connect rail mount that includes a lever lock.

Example 20 relates to an optical system comprising a first optical device having a fixed magnification; and a second optical device as defined by any of Examples 1-19.

Example 21 includes the subject matter of Example 20, wherein the first optical device and second optical device each comprise a mechanism to secure the optical device to a rail.

Example 22 includes the subject matter of Example 20 or 21, wherein the first optical device comprises one or more of a scope, a night-vision imager, a thermal imager, and an optical sighting device.

1. An optical device comprising:
an afocal magnifying lens train comprising a plurality of optical elements;
an alignment adjustment mechanism to tilt, tip, or move one or more of the optical elements of the afocal magnifying lens train; and
a clamp mechanism to secure the optical device to a rail or to another optical device.

2. The optical device of claim 1, wherein the afocal magnifying lens train comprises one or more lenses to magnify or demagnify an image of an object.

3. The optical device of claim 1, wherein the afocal magnifying lens train comprises lenses that receive light and transmit light with zero or close to zero net convergence of light.

4. The optical device of claim 1, wherein the afocal magnifying lens train comprises an objective lens proximate to a first end of the optical device and an ocular lens proximate to a second end of the optical device opposite the first end.

5. The optical device of claim 1, wherein the afocal magnifying lens train comprises a catadioptric system.

6. The optical device of claim 5, wherein the catadioptric system comprises an objective lens and a mirror lens.

7. The optical device of claim 6, further comprising an electronic device proximate the objective lens.

8. The optical device of claim 7, wherein the electronic device is positioned within one or more of a cavity defined by the objective lens and a cavity defined by a mirror of the mirror lens.

9. The optical device of claim 8, wherein the electronic device comprises one or more of an internal display, a laser range finder, an infrared detector, a night-vision imager, a thermal imager, and an optical sighting device.

10. The optical device of claim 9, wherein the electronic device is configured to project an image that is overlaid on a real image provided by the afocal magnifying lens train.

11. The optical device of claim 1, further comprising:
a first cradle to support a first set of optical elements of the afocal magnifying lens train, the first set comprising an objective lens; and
a second cradle to support a second set of optical elements of the afocal magnifying lens train, the second set comprising an ocular lens.

12. The optical device of claim 11, wherein the alignment adjustment mechanism is to tilt, tip, or move one or more of the first set of optical elements.

13. The optical device of claim 11, wherein the alignment adjustment mechanism is to tilt, tip, or move one or more of the second set of optical elements.

14. The optical device of claim 1, further comprising a focus adjustment mechanism to move the one or more optical elements of the afocal magnifying lens train along an optical axis of the afocal magnifying lens train to adjust a focus of the afocal magnifying lens train.

15. The optical device of claim 1, wherein the alignment adjustment mechanism is a first alignment adjustment mechanism to tilt, tip, or move one or more of the elements along a first axis, and the optical device further comprises a second alignment adjustment mechanism to tilt, tip, or move one or more of the optical elements along a second axis orthogonal to the first axis.

16. The optical device of claim 1, wherein the clamp mechanism comprises a rail mount.

17. The optical device of claim 16, further comprising an adapter to surround an objective lens of another optical device.

18. The optical device of claim 1, wherein the clamp mechanism comprises a clamp to mount the optical device onto another optical device.

19. The optical device of claim 1, wherein the clamp mechanism comprises a quick connect rail mount that includes a lever lock.

20. An optical system comprising:
a first optical device having a fixed magnification; and
a second optical device coupled to the first optical device, comprising an afocal magnifying lens train comprising a plurality of optical elements to magnify or demagnify an image of an object with zero or close to zero net convergence or divergence of the incoming light.

21. The optical system of claim 20, wherein the second optical device further comprises an alignment adjustment mechanism to tilt, tip, or move one or more of the optical elements of the afocal magnifying lens train.

22. The optical system of claim 21, wherein the alignment adjustment mechanism is a first alignment adjustment mechanism to tilt, tip, or move one or more of the optical elements of the afocal magnifying lens train along a first axis, and the second optical device further comprises a second alignment adjustment mechanism to tilt, tip, or move one or more of the optical elements of the afocal magnifying lens train along a second axis orthogonal to the first axis.

23. The optical system of claim 20, wherein the second optical device further comprises a focus adjustment mechanism to move one or more of the optical elements of the afocal magnifying lens train along an optical axis of the afocal magnifying lens train to adjust a focus of the afocal magnifying lens train.

24. The optical system of claim 20, wherein the first optical device and second optical device each comprise a mechanism to secure the optical device to a rail.

25. The optical system of claim 20, wherein the first optical device comprises one or more of a scope, a night-vision imager, a thermal imager, and an optical sighting device.
